(19) United States
(12) Patent Application Publication
(10) Pub. No.: US 2010/0252655 A1
(43) Pub. Date: Oct. 7, 2010

(54) Pest Deterrent System

(76) Inventors: Dan Milner, Even Yehuda (IL); Ze'ev Efrat, Ramat Hasharon (IL)

Correspondence Address: NAOMI ASSIA C/O;LANDON IP, INC, 1725 JAMIESON AVENUE, ALEXANDRIA, VA, 22314, US

(21) Appl. No.: 12/739,958

(22) PCT Filed: Oct. 22, 2008
(86) PCT No.: PCT/IL08/01372

§ 371 Date: Apr. 27, 2010

(30) Foreign Application Priority Data
Oct. 28, 2007 (IL) 186962

(51) Int. Cl. B05B 15/00

(52) U.S. Cl. 239/289

(57) ABSTRACT

The present invention generally provides a modular electronic pest deterrent system associated with irrigation tubing, useful to frighten away animals that are harmful to crops.

### FIELD OF THE INVENTION

The present invention relates generally to pest deterrent systems, useful to frighten away animals that are harmful to crops.

### BACKGROUND OF THE INVENTION

Orchards and fields are subject to marauding by birds, rodents and other creatures. Farmers must contend with loss of crops caused by various creatures, which often attack seasonally and cause extensive economical damage to produce and to agricultural equipment such as irrigation tubing. Birds tend to peck at dripper tubing draped upon trees, in order to quench their thirst, leaving enlarged holes from which an abundance of water can escape. Rodents similarly damage dripper tubing placed upon the ground or buried underground. Large volumes of fluid are needlessly wasted. This damage lowers the water pressure further down the line, so that crops downstream will not receive sufficient irrigation. Puddles are formed around the damaged area of tubing; such puddles can be detrimental to the surrounding crop.

One solution is to apply one of the many pesticides which is suited to act against the most damaging creature (birds, mammals, rodents); however this is not environmentally safe, as these materials are health hazardous by ingestion in large quantities, and by repeated inhalation or contact. This solution is therefore less than ideal, being harmful to the end-consumer of the produce, and to the farmer who handles and applies the pesticide.

Agricultural growers of organic produce are especially limited in their ability to fight against damage to crops or to agricultural equipment. All substances used to encourage growth or prevent spoilage of organic produce, must be selected from a list of natural or harmless materials approved for use on organic produce.

Various scarecrows have been developed to address this problem. See, for instance, U.S. Pat. No. 4,598,660 to Konzak and International Publication WO04/049796A1 to Nickerson. The various scarecrows may visually resemble birds of prey, and may be hung or floated above the field. Alternatively, brightly patterned materials may be used, which may move by the wind or may have an associated motor. The drawback to these classical or electrical scarecrows is that birds and other creatures rapidly become familiar with them, and therefore they are only effective for a short amount of time. Devices have even been developed which deliver an electrical shock to animals which come into electrical contact with the device, which illustrates the gravity of the pest problem for landowners and farmers.

Additional pest deterring devices rely on auditory emissions which are frightening to the creature against which they are directed. While certain animals may be repelled by auditory stimuli which are not within the wavelengths heard by the human ear, others, such as birds, hear only sounds detectable by humans. Therefore deterrents have been developed which rely on use of air-guns, whistles, or the like. These are obviously frowned upon in urban areas, since they disturb the peace.

The need exists for an improved pest deterrent system which is environmentally friendly, being harmless to the creatures it deters, while being effective in repelling living creatures from damaging crops or agricultural irrigation equipment. Such a system should be sufficiently rugged so as to withstand outdoor weather extremes over a period of approximately one year, without the need of repair. Preferably, a farmer should be able to easily deploy the system, in a time-saving manner.

Prior art electronic deterrent devices require input of external energy in order to operate. Prior art devices do not supply their own electrical energy, rather they rely on power supplies, or are connected to a power grid, and thus they do not have any source of renewable electrical power. A small number of devices utilize solar energy; however their operable time period is therefore limited to daylight hours and to sunny days.

It is the object of the present invention to provide a pest deterrent system which overcomes the above drawbacks, and is capable of providing its own electrical power.

These and other objects will become more apparent in view of the Detailed Description that follows.

### SUMMARY OF THE INVENTION

The present invention provides a system for deterring pests from an area of crop growth, comprising:
a. irrigation means;
b. at least one power generating module adapted to convert fluid flow within said irrigation means into electrical power;
c. No wiring or electric connections are needed and therefore the system is easy to use and poses no electric hazard;
d. pest deterring modules capable of emitting pest deterring effects; and
e. control means for programming and controlling said system; wherein said control means are in electrical communication with said at least one power generating module and with said pest deterring modules.

### BRIEF DESCRIPTION OF THE DRAWINGS

For a better understanding of the invention, with regard to the embodiments described, reference is made to the accompanying drawings, in which:

FIG. 1A is an overview of the system of the invention.

FIG. 1B illustrates the location of dripper emitters according to one embodiment.

FIG. 1C illustrates an embodiment in which irrigation fluid is returned for recycling.

FIG. 2 is illustrates the basic energetic flow occurring within the system.

FIG. 200 provides a more detailed description of circuits 290 and 292 of FIG. 2, constructed according to the principles of the present invention.

FIG. 3 illustrates a Motion Generating Module (MGM).

FIG. 4 illustrates an MGM after physical and electrical connection to irrigation tubing.

FIG. 5, illustrates an alternative embodiment of an MGM, which performs a linear pop-up upon activation of the MGM.

FIG. 6 and FIG. 7 illustrate additional motion options of the MGMs.

FIG. 8 illustrates an MGM in cut-away view, showing electromechanical activation mechanism.

FIG. 9 illustrates an alternative MGM in cut-away view, showing hydro-electrical activation mechanism.

FIG. 10 illustrates an alternative embodiment of an MGM.

FIG. 11 is a schematic representation of a Sound Generating Module (SGM).

FIG. 12 shows one embodiment of a Power Generating Module (PGM).

FIG. 13 shows internal structures of the turbine of the PGM.

FIG. 131 shows the magnetic rings of FIG. 13 as being built of segments with alternating North and South flux directions respectively.

### DETAILED DESCRIPTION OF THE INVENTION

The present invention generally provides a modular electronic pest deterrent system associated with irrigation tubing, and is capable of generating its own electrical supply. The fluid flow occurring within the irrigation piping is utilized to generate electrical power, which is utilized to power components of the system. The generated electrical power is stored and later released upon demand. The system is thus environmentally friendly, being harmless to the pests it deters, and is non-polluting. The system creates and utilizes a rechargeable energy source. The system of the present invention is mounted on the irrigation system and requires no wiring and no electrical connections.

The deterrent system is adaptable for use with irrigation tubing which supplies water to fields, to greenhouses, or to orchards. The irrigation tubing may be located above ground or underground. The system is programmable to emit one or more effects which frighten away pests, thus preventing pests from damaging crops or agricultural equipment. The pest deterring effects include sound, motion and vibration of parts of the system.

The various aspects pertaining to the nature of the effect can be readily programmed, to achieve maximum deterrent properties suited to the most threatening pest known for each crop. These programmable aspects of the effects include for instance, the duration of the effect, the intervals between each effect, and the volume of the effect. Additional programmable aspects of the effects are described herein below. Randomization of the timing of the effects is also provided in the invention, as discussed herein below.

In the following description, the irrigation tubing is described as relating to a dripper irrigation system. This description is for illustrative purposes only, and is not intended to limit the scope of the invention. One can envision use of the system of the invention with various irrigation systems other than dripper systems, such as sprinkler systems and the like.

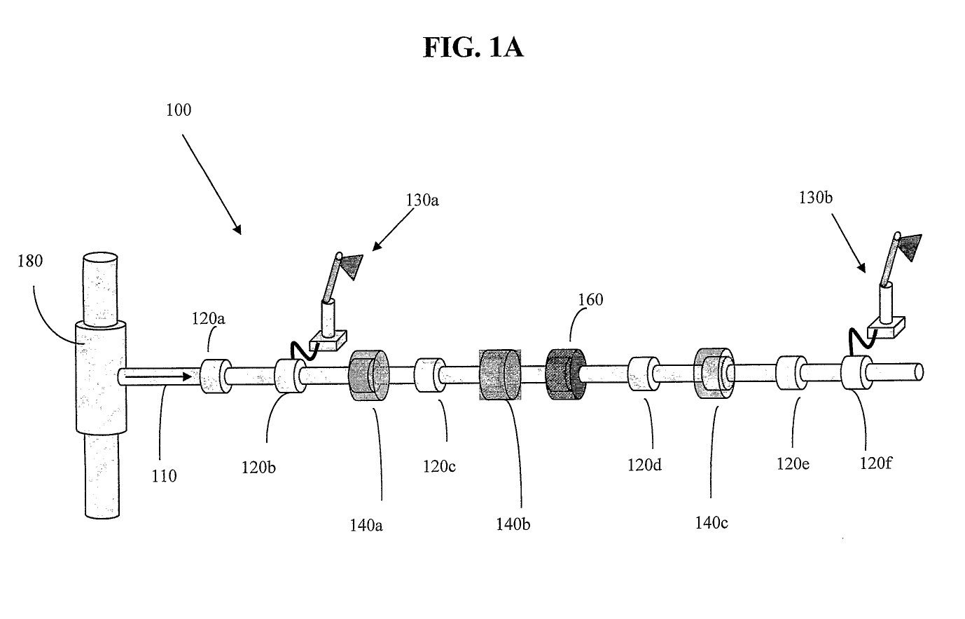

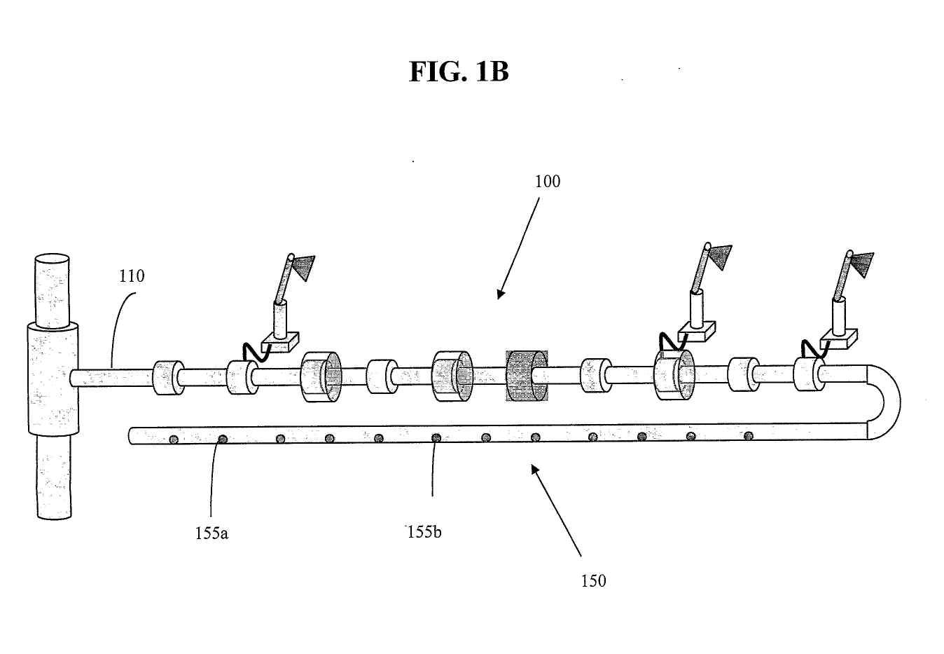

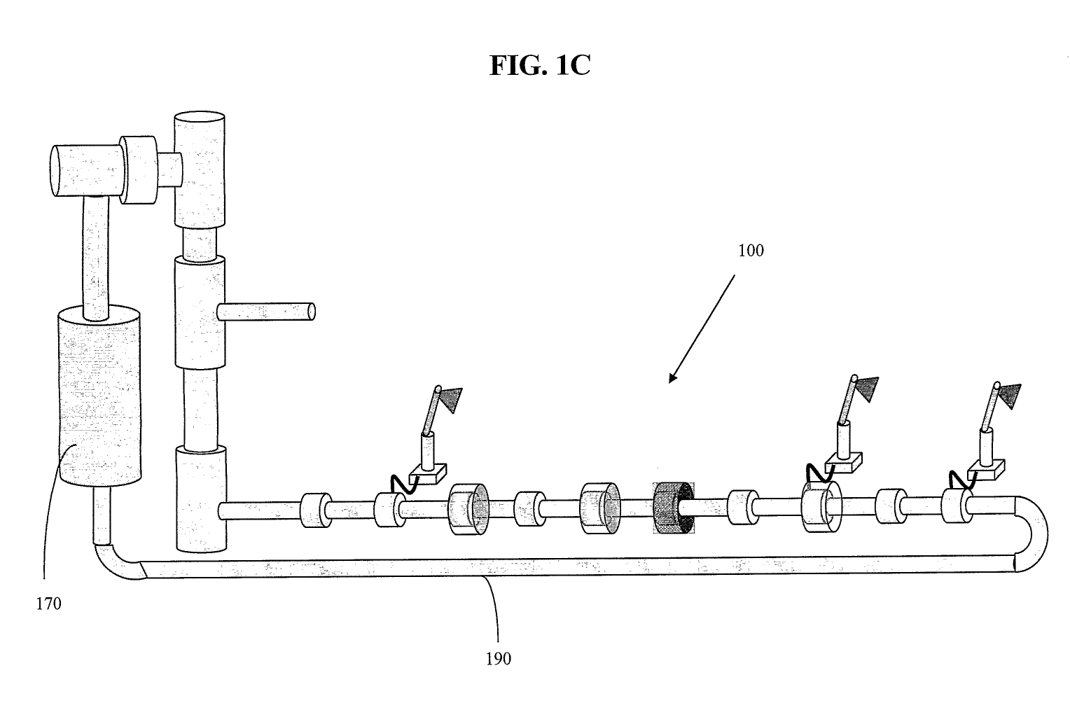

Referring to FIG. 1A, an overview of the system 100 of the invention is shown. Irrigation tubing 110 is positioned between rows of crops, or is draped upon tree branches in an orchard.

Attached to the tubing 110 at various predetermined intervals are the essential components of the system:
1. Power Generating Modules (PGMs) (120a-f) which utilize the flow of water within the tubing 110 to generate and optionally to store electrical power. This electrical power is released as required and used to activate components of the system. Power Generating Modules (120a-f) can optionally be embedded in the irrigation tubing during extrusion of the tubing in the factory.
2. Pest deterring modules, which can be selected from one or more of the following: Sound Generating Modules (SGMs) 140a, 140b, 140c, which emit audible effects that deter pests. Additionally or alternatively, Motion Generating Modules (MGMs) 130a, 130b, may be used, which propel moving parts in various directions. The moving parts can for instance, resemble predators, or can be brightly colored for maximum deterrent value. Additionally, vibratory effects emitted from Vibratory Generating Modules (VGM) 160 may be included in the system 100. Vibratory effects are especially suited for use with dripper tubing which is buried below ground level. One can envision any number of additional pest deterring effects which may be included in the system 100, and may be powered by the PGMs 120 of the invention.
3. Control means for programming and controlling the system are present in the system. The control means are in electrical communication with the power generating modules 120 (a-f) and with the pest deterring modules. A central control unit may be included in the system, or each pest deterrent module may be controlled by its respective control unit.

These essential components are preferably attached to “blind” tubing 110, which has no dripper emitters and therefore no release of irrigation fluid to the field.

A pressure regulator 180 may be included in the system 100, so that the water pressure entering the system via tubing 110 measures 2-4 Atm.

Referring to FIG. 1B, in one embodiment, dripper emitters 155a, 155b are included in dripper tubing 150 further downstream in the system.

Referring to FIG. 1C, in another embodiment, irrigation fluid is returned to the system downstream from the essential components of the system such as via return tubing 190. The fluid can then be recycled for use, after passage through recycling system 170. Dripper emitters are not included in the tubing upon which the essential components of the system are mounted.

In FIG. 1A-1C, a PGM is shown attached to each MGM. This is for illustrative purposes only; the number of PGMs included in the system may vary, and fewer PGMs may be necessary. Those components requiring electrical energy are in electrical communication with a PGM, so that, for instance, the Sound Generating Modules (SGM), and vibratory modules (VGM) receive sufficient electrical energy from the PGM(s) of the system.

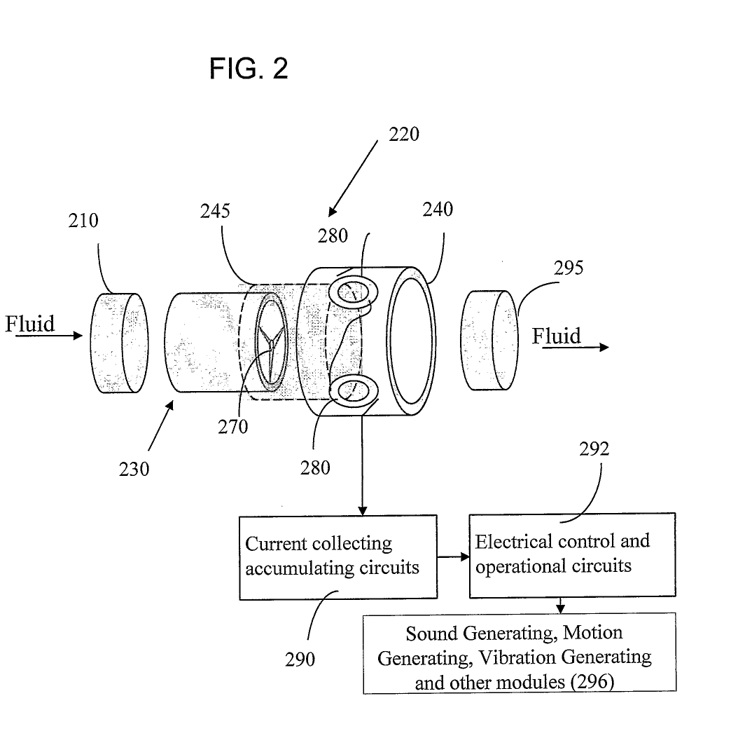

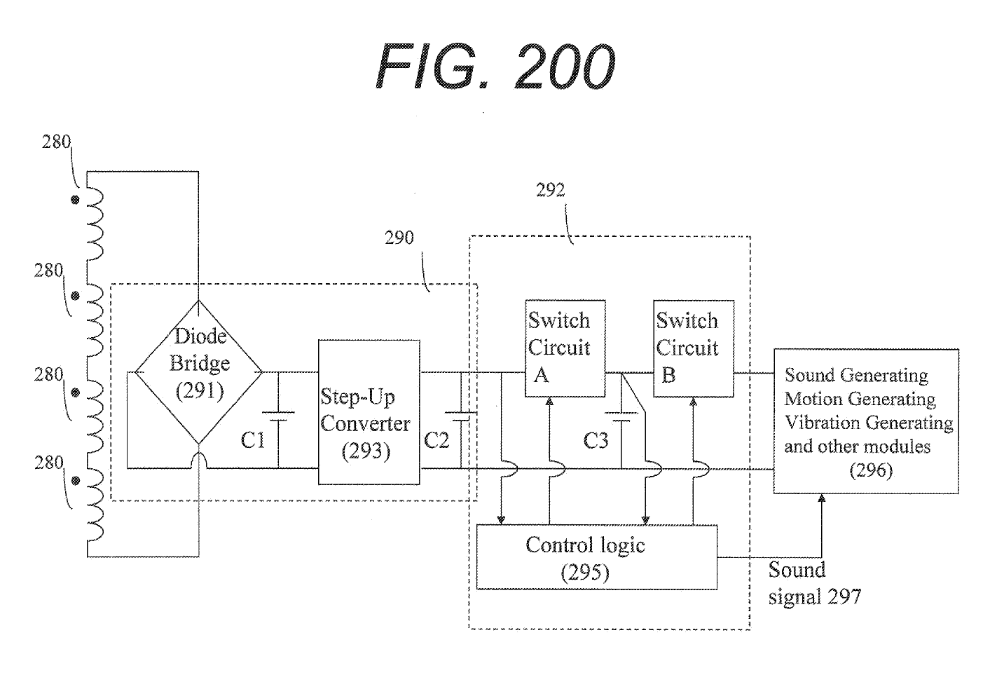

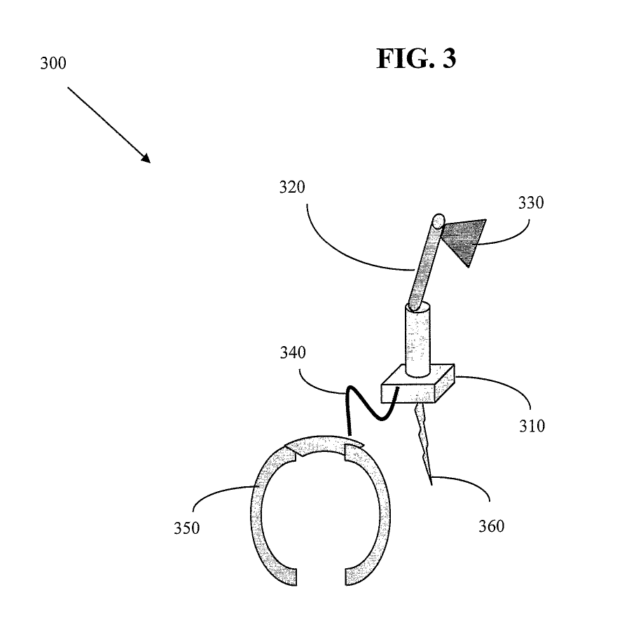

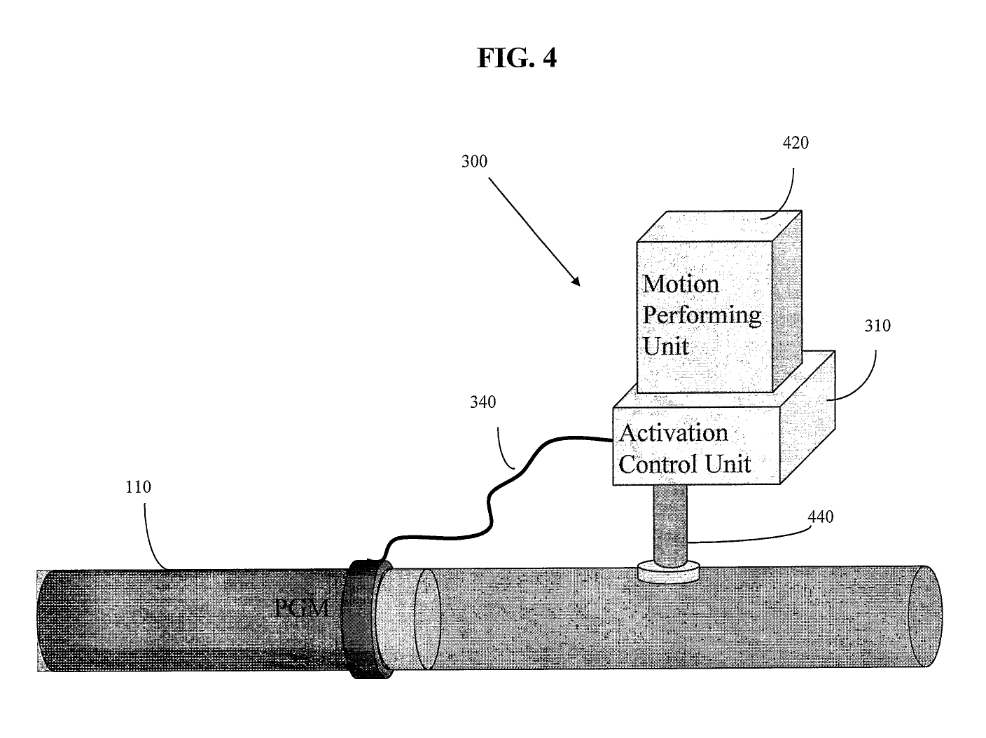

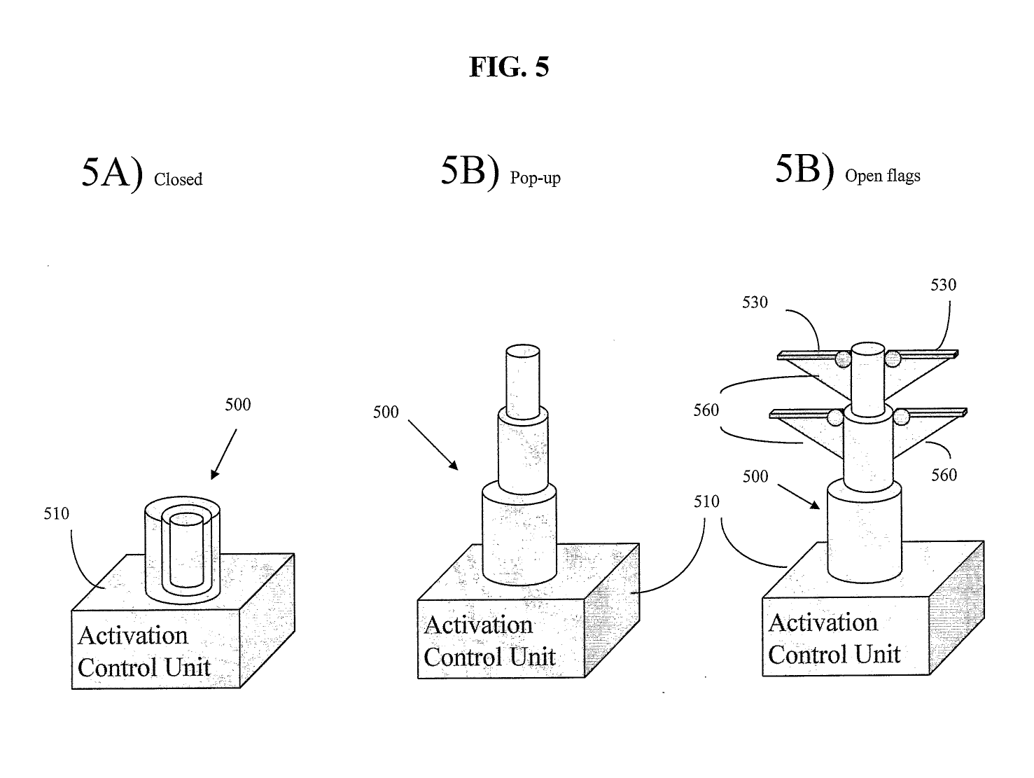

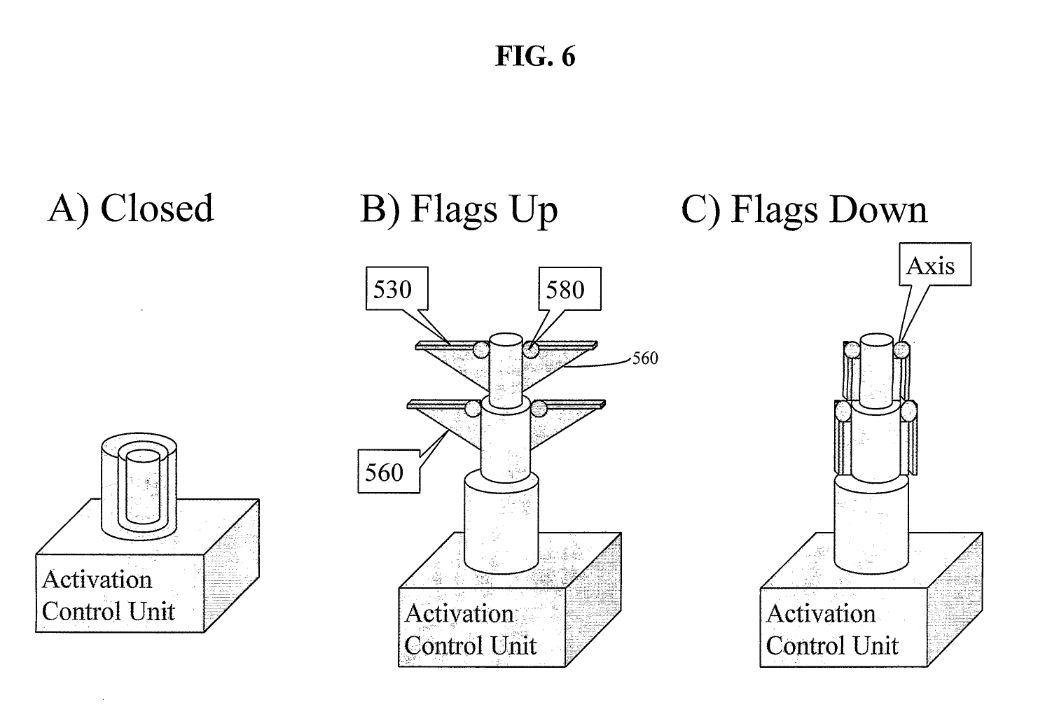

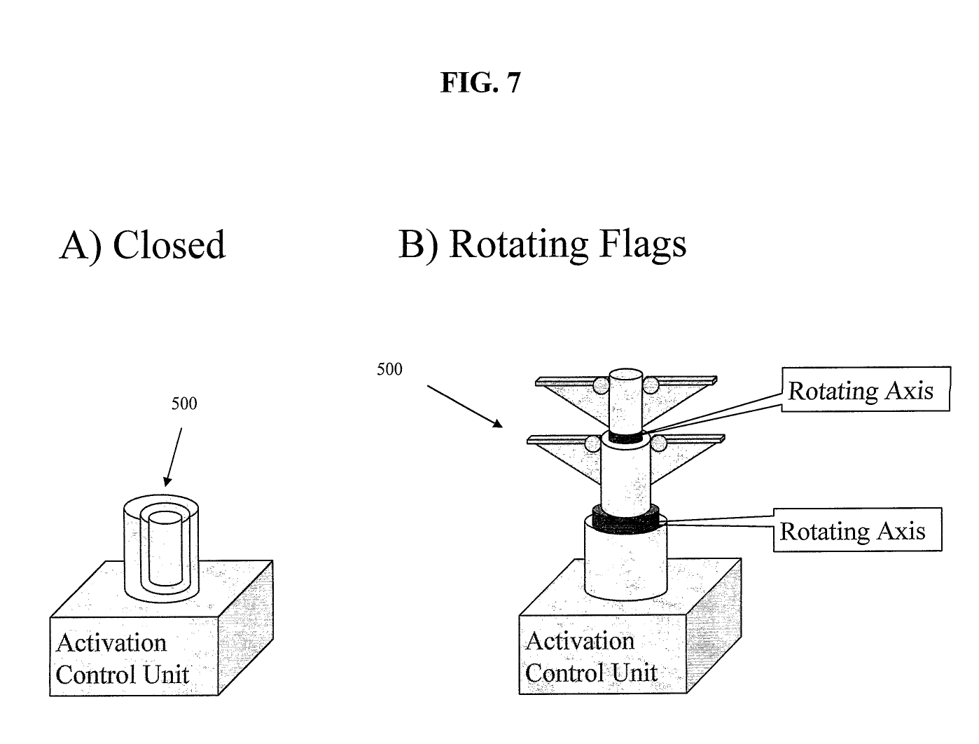

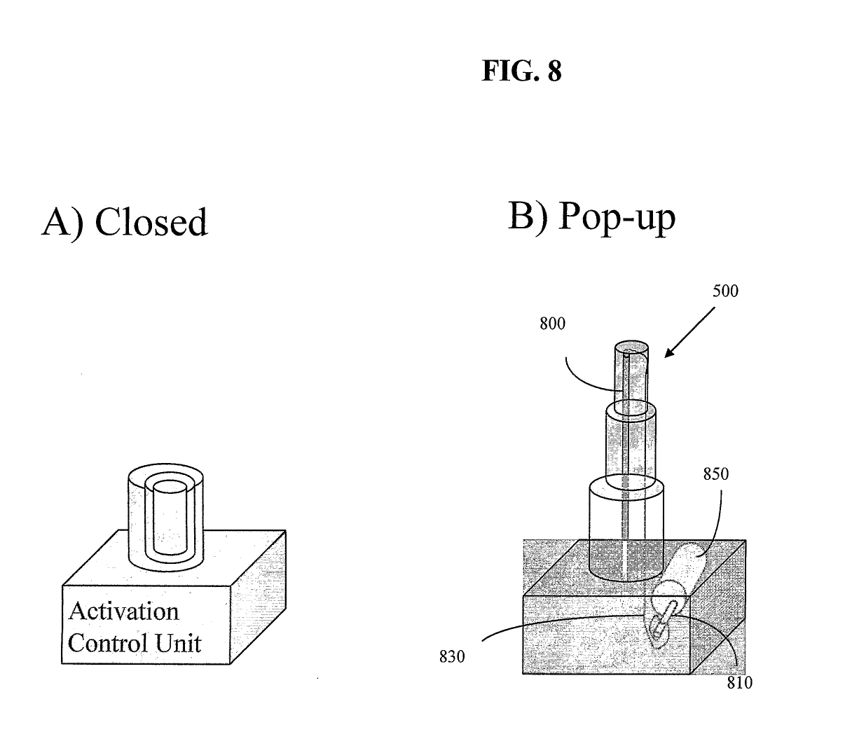

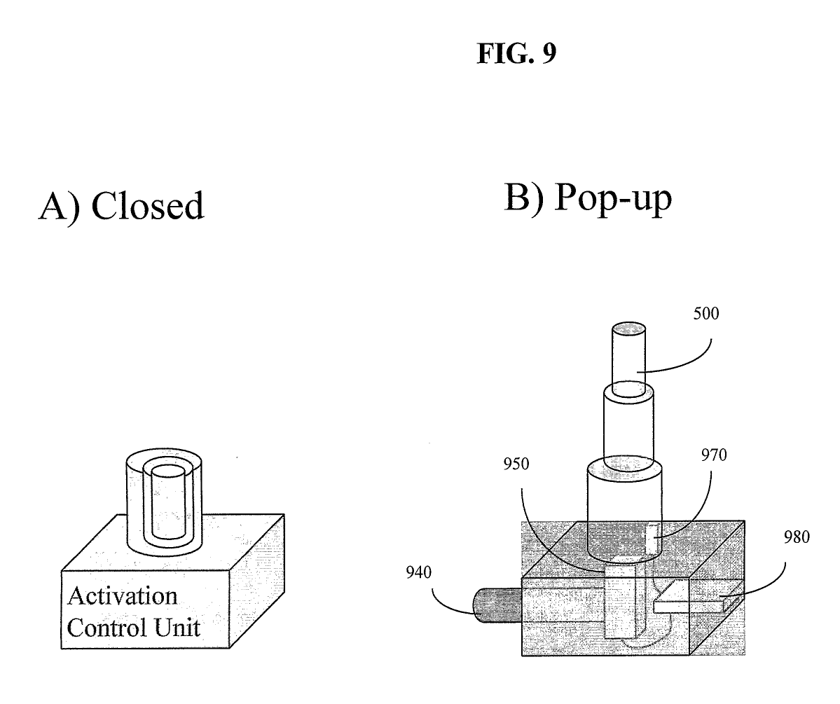

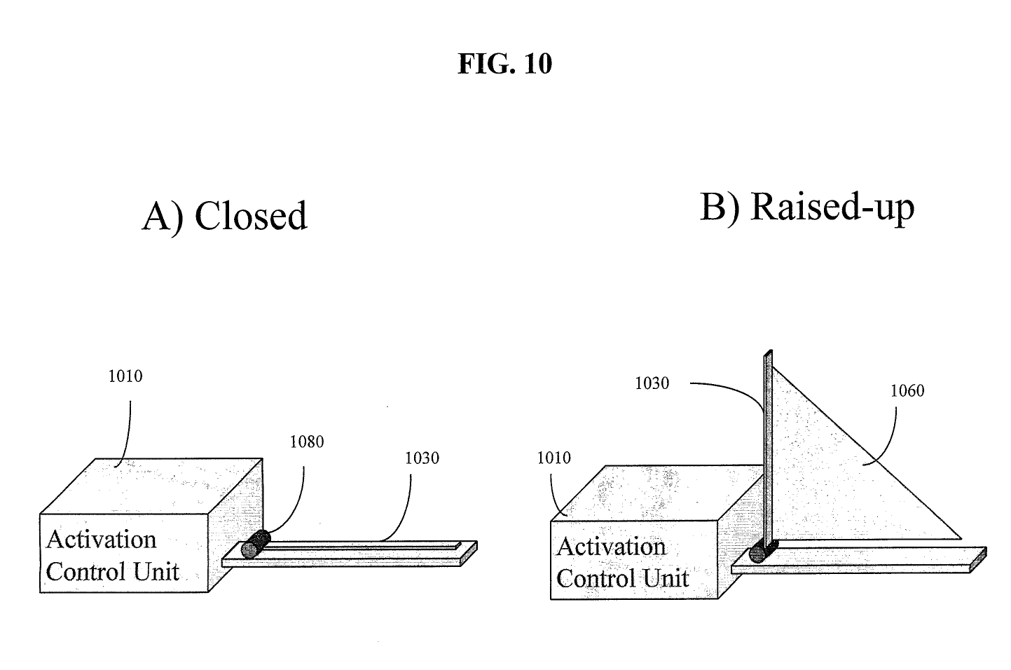

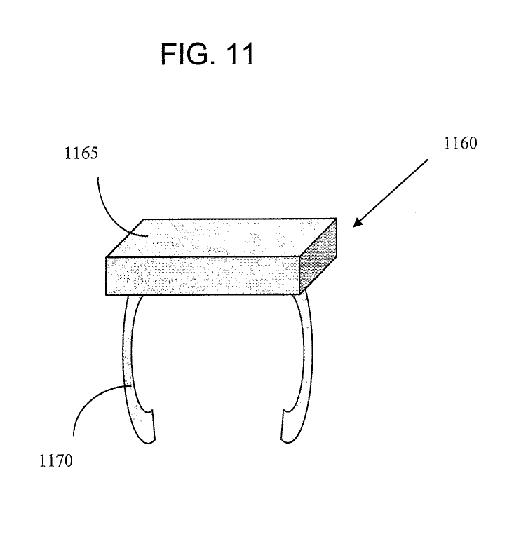

Referring to FIG. 2, the basic energetic flow occurring within the system is illustrated. Fluid flow within the irrigation means is initiated by the control unit (not shown), such that irrigation fluid moves through an inlet flow device 210. The irrigation fluid then enters the Power Generating Module (PGM) 220, which in FIG. 2 is represented by a magnetic rotating device 230, such as a turbine (described herein below in relation to FIGS. 12 and 13). Magnetic rotating device 230 is comprised of a propeller 270 and associated cylindrical magnets, which are located coaxially to the propeller axis. Magnetic rotating device 230 and associated magnets rotate in response to fluid flow within the irrigation tubing. Stator 240, which surrounds magnetic rotating device 230, comprises metallic coils 280. Thus, flow of irrigation fluid acts to rotate propeller and associated magnets relative to stator and coils, generating magnetic flux 245. The magnetic flux is transferred to current collecting and accumulating circuits 290. The electrical energy passes to control and operational circuit 292 upon a suitable microprocessor. The electrical current is controlled and outputted as necessary to either a rechargeable battery, a capacitor, a diode or to other components of the system (SGM, MGM, VGM, etc.). Irrigation fluid leaves the PGM as outlet flow via fluid outlet device 295, and is released to the crop or is recycled.

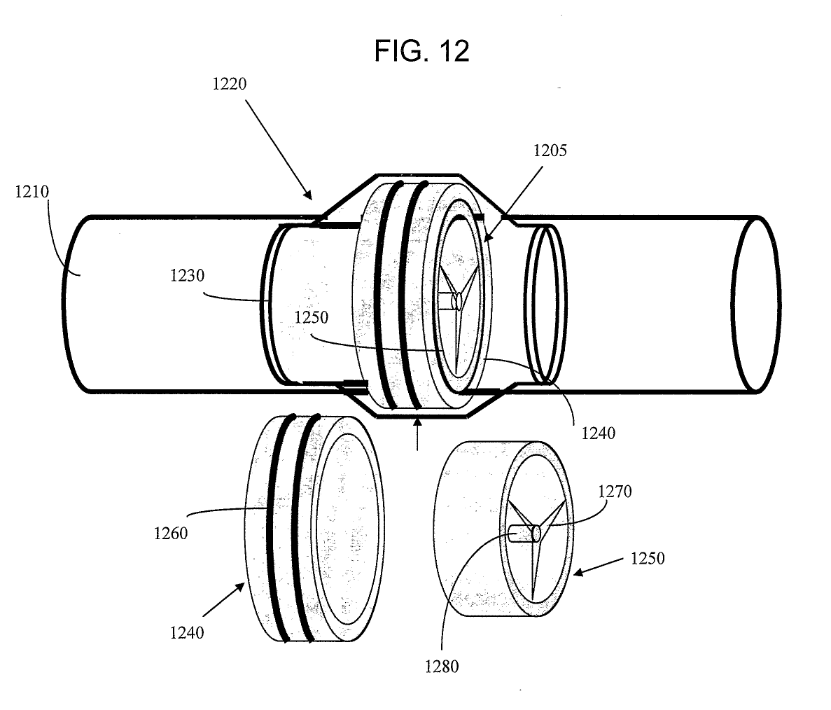

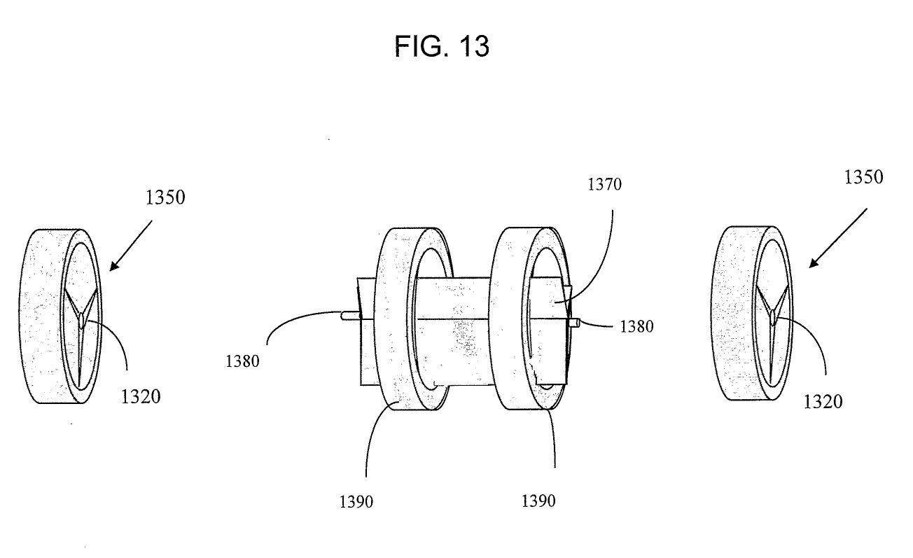

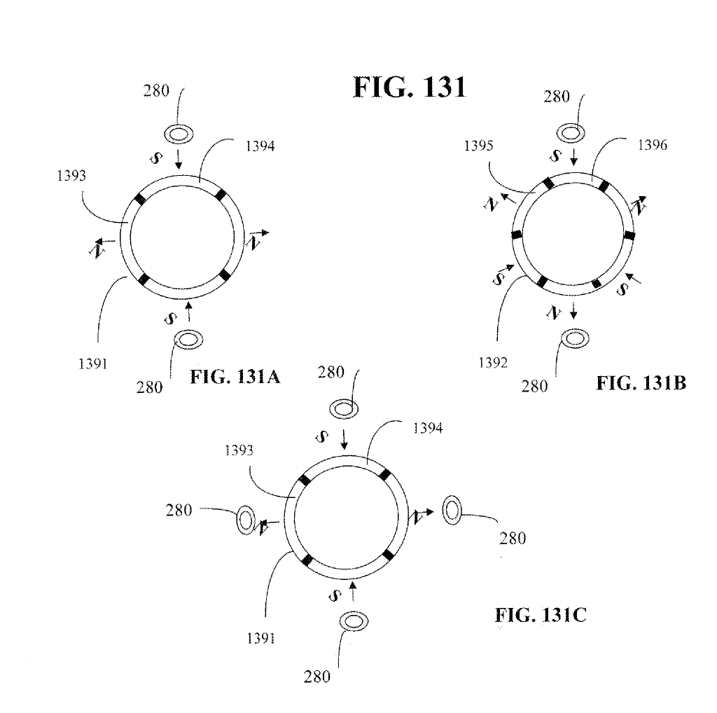

FIG. 200 provides a more detailed description of exemplary circuits 290 and 292 of FIG. 2, constructed according to the principles of the present invention. Solenoids 280 are connected appropriately to deliver their generated current in the additive direction to impart an alternating sine wave. Current collecting and accumulating circuit 290 is constructed of a Rectifier Bridge 291, a capacitor C1, a step-up converter 293 and a capacitor C2, which together provide the appropriate voltage level for all other circuits. Control and operational circuit 292 contains Switches A and B, capacitor C3 and the control logic 295. Control logic 295 senses the voltage level on C2 and if adequate will open Switch A to load capacitor C3. After capacitor C3 is at the appropriate level and control logic 295 decides, based on a random algorithm, to operate the attached Sound Generating, Motion Generating, Vibration Generating and other modules 296, it would open Switch B. For the sound module, for example, control logic 293 provides prerecorded sounds to increase and personalize the sound effects corresponding to various bird types and other pests.

FIG. 3 through FIG. 10, pertain to various embodiments of a Motion Generating Module (MGM) according to the principles of the present invention.

Referring to FIG. 3, a Motion Generating Module (MGM) is shown, according to one embodiment. The MGM 300 is comprised of a base unit 310 which contains mechanical components which are selectively activated to maneuver moving parts, such as the expansion arm 320 which terminates in a highly visible flag 330. The base unit 310 may additionally contain the control unit and appropriate circuitry for determining the timing sequence for activation of the MGM 300. Connecting tail 340 electrically connects the MGM 300 to the PGM, thus supplying electrical energy to the MGM. Connecting tail 340 may terminate in retention band 350, which comprises electrical connection points allowing electrical connection to the PGM. Retention band 350 spring-clamps MGM 300 to irrigation tubing. Optionally, anchor 360 is present to penetrate surrounding soil, to hold MGM 300 in place of interest.

Referring to FIG. 4, MGM 300 is illustrated after physical and electrical connection to irrigation tubing 110. MGM 300 is shown schematically to be comprised of a motion performing unit 420, which undergoes motion when activated by base unit 310. Motion performing unit 420 was previously depicted in FIG. 3 as expansion arm 320. Drop pipe 440 optionally allows fluid flow from irrigation tubing 110, into MGM 300, as described herein below in relation to FIG. 9.

Referring to FIG. 5, one embodiment of an MGM is illustrated, which performs a linear pop-up upon activation of the MGM. In FIG. 5A, the MGM is closed, with the motion performing unit represented by telescoping cylinders 500, which are collapsed upon each other. In FIG. 5B, base unit 510 initiated pop-up of the telescoping cylinders 500. In FIG. 5C, after pop-up occurred, arms 530 extended from within telescoping cylinders 500, unfurling flags 560 which are formed of highly visible material. The pest deterring effect achieved is therefore visual in nature.

Referring to FIG. 6, repetitive extension and retraction of arms 530 occurs upon axis 580, resulting in flags 560 being waved, for a highly visual effect. Flags 560 will appear to cycle from an unfurled state or “flags up” state in FIG. 6B, to a “flags down” state in FIG. 6C.

Referring to FIG. 7, telescoping cylinders 500 optionally rotate upon longitudinal axis as shown, forming a module having rotating flags. Stepping and rotational motors are present in the MGM as necessary.

Referring to FIG. 8, the MGM is illustrated in FIG. 8B in cut-away view, showing internal structures schematically. An electromechanical activation mechanism is utilized in this embodiment to initiate the pop-up. Actuator spring 800, which may be made of Nitinol, extends to initially propel popping-up of telescoping cylinders 500 to “opened state”. In order to close cylinders to the closed state shown in FIG. 8A, motor 850 is activated after a predetermined time, to revolve shaft 810, which winches in pulling wire 830 attached to the upper extremity of the telescoping cylinders 500.

Referring to FIG. 9, alternatively, a hydro-electrical mechanism is utilized to activate and deactivate the pop-up. In FIG. 9B, drop-pipe 940 allows entry of irrigation fluid originating in irrigation tube, into telescoping cylinders 500, via entry valve 950. Fluid volume within telescoping cylinders 500 results in popping up of the cylinders 500 to the opened state shown in FIG. 9B. After a predetermined time period, exit valve 970 is opened to allow exit of fluid from within telescoping cylinders 500, resulting in closing of cylinders 500 to the closed state shown in FIG. 9A. Control circuit 980 dictates opening and closing of entry and exit valves, 950 and 970 respectively.

Referring to FIG. 10, another embodiment of an MGM is illustrated, in which activation of the unit results in rise of flag 1060 from a closed state (FIG. 10A) to a raised state (FIG. 10B). Movement of flagpole 1030 upon axis 1080 is controlled by base unit 1010, and results in flag 1060 being raised. Movement of flagpole 1030 can be generated electromechanically, or hydro-electrically, as discussed hereinabove in relation to FIG. 8 or FIG. 9 respectively.

Referring to FIG. 11, a schematic representation of a Sound Generating Module (SGM) is shown. SGM 1160 is comprised of a housing 1165, holding within components necessary to emit sound deterring effects. These include electronic circuitry and hardware for producing sound, preferably: a sound memory retained within a flash memory device, a speaker-driver, a voltage level handler, and a super-cap/capacitor. Control of timing and other aspects of the sound effects emitted by the SGM, is programmable via microprocessor present within SGM. This allows a user to tailor the sound to best deter particular pests which are most damaging to the crop. The sound may be tailored to be optimal for deterring those pests most prevalent in the specific season or prevalent at the geographic location of interest.

Randomization of the timing of the sound effects is utilized, to prevent pests from learn any fixed pattern within inherent in the sound effects.

In one embodiment, the sound deterring effect provided is comprised of pre-recorded sounds made by animals in distress or other deterrent sounds relevant to other problem situations. Such sounds have been scientifically proven to efficiently deter a wide variety of animals away from a predetermined area.

Programmable aspects of the sound include the sound frequency (wavelength), volume level, etc. SGM 1160 is held upon irrigation tubing by means of bracelet 1170. Bracelet 1170 additionally contains electrical wiring allowing connection of the SGM 1160 to a PGM, which supplies electrical current necessary for activation of the SGM.

Referring to FIG. 12, one embodiment of a Power Generating Module (PGM) is shown. The PGM 1220 comprises a turbine 1205, which is held within irrigation tubing 1210 by snap-in connector 1230. Turbine 1205 comprises a stator 1240, concentrically disposed over axis holders 1250. Stator 1240 includes metallic coils (best seen in FIG. 2). Propeller 1270 is surrounded by associated magnets (shown in FIG. 13), which rotate along with propeller. Propeller 1270 is held upon shaft 1280; shaft 1280 protrudes from extremities of propeller and enters appropriate apertures in each axis holder 1250. When irrigation fluid flows past turbine 1205, turbine propeller 1270 will be rotated by irrigation fluid. The rotation of the propeller-associated magnets, in relation to the coils of the stator, causes magnetic flux. The resultant raw electrical energy generated, passes out of the PGM via electrical connection 1260. The electrical energy is transferred to a capacitor (not shown), before being released to power the system.

Referring to FIG. 13, internal structures of the turbine of the PGM are shown. Propeller 1370 is held upon shaft 1380 which protrudes from center of propeller 1370. Protruding ends of shaft 1380 enter appropriate apertures 1320 present upon axis holders 1350. Shaft 1380 is specifically designed to lower the friction occurring during rotation of propeller 1370. Propeller 1370 wings are angled somewhat relative to the direction of flow of irrigation fluid; the angle is best suited to provide maximal rotation and thus maximal energy. Associated magnetic rings 1390 surround propeller 1370, and rotate along with propeller 1370.

Referring to FIG. 131, the magnetic rings 1391, 1392 and 1393 are built of segments with alternating North 1393 and 1395, and South 1394, 1396 flux directions respectively. Magnetic ring 1391 composes 4 such segments and magnetic ring 1392 composes six such segments. These configurations are illustrated in FIGS. 131 A, B and C as optional configurations. This arrangement increases the frequency and the rate of the flux change. Since the generated current in the solenoids is proportional to dB/dt, the higher rate of change will produce higher current and as a consequence higher power. Optionally, additional secondary magnets or metallic balls may be included in the turbine.

In an exemplary embodiment, the present invention conforms to the standards for dripper irrigation.

In an exemplary embodiment, the distance between each PGM is approximately 2-3 m, but this will vary according to the distance between sound generators and their sound volume.

As the system is modular, the number of PGMs, as well as the number and type of pest deterring module can be varied on site. The user may determine which type of pest deterring effect is best suited to the needs at a given season or location, and may choose whether to include auditory, vibratory, motion, visual effects, etc. The distance between each pest deterring module may be selected on-site. Each module may be connected at various connection points upon the irrigation tubing.

The various aspects of the pest deterring effects emitted may be programmed by the user, using the control means. These programmable aspects include the duration of the effect, the intervals between each effect, the volume of the effect, the extent of movement of a moving part of said system, the sequence of a plurality of said effects, the audio frequency of an audio effect, and the vibration frequency of an effect. A randomizing of the timing of effects is programmed into the system, to avoid pests becoming overly familiar with the effects, and to prevent all effects from being emitted simultaneously for a lengthy period of time.

Vibratory effects may be emitted by including a vibrator within the turbine of the PGM. The flow of the irrigation fluid may act to manipulate a moving part which directly vibrates a portion of the irrigation tubing.

As the system is intended for outdoor use, its modules and electrical wiring must be water-proof and rugged, able to withstanding outdoor humidity and temperature conditions. Preferably, the system can withstand temperatures within the approximate range of −40 to 60° C.

Irrigation tubing is typically deployed by unrolling lengths of tubing from an oversized drum. Preferably, the system of the invention may be similarly wound or unwound from a drum, with its various modules attached to the wound irrigation tubing. This will allow a user to easily deploy the system in the field. Preferably, the size and shape of the various modules should not prevent winding and unwinding of the irrigation tubing upon the drum.

The present invention thus provides a pest deterring system which is novel in supplying its own electrical power, from a rechargeable source. The system is preferably modular, and can thus be best suited to a particular area and to the needs of a user. Various aspects of the pest deterring effects emitted are programmable, to achieve maximum pest deterring results. The timing of the effects provided is randomized, so that the pests will not learn any fixed pattern within the system.

The system of the invention is thus highly advantageous over prior art systems, which do not supply their own power, and are readily acclimatized to, and thus are generally ignored by pests.

Having described the invention with regard to certain specific embodiments thereof, it is to be understood that the description is not meant as a limitation, as further modifications will now become apparent to those skilled in the art, and it is intended to cover such modifications as are within the scope of the appended claims.

1. A system for enabling the extraction of energy in an irrigation tube characterized by low water pressure and low flow rate.

2. The system according to claim 1, wherein said system enables deterrence of pests from an area of crop growth irrigated by a plurality of said irrigation tubes, said system comprising:
a) irrigation means, comprising at least said plurality of said irrigation tubes;
b) at least one power generating module adapted to convert fluid flow within said irrigation means into electrical power;
c) pest deterring modules capable of emitting pest deterring effects; and
d) control means for programming and controlling said system; wherein said control means are in electrical communication with said at least one power generating module and with said pest deterring modules.

3. The system according to claim 2, wherein said pest deterring effects emitted act to deter pests from damaging crops or agricultural equipment, and are selected from at least one of the following group: audio effects, motion effects propelling moving parts of said system, vibratory effects, and visual effects.

4. The system according to claim 2, wherein said control means are programmable, allowing a user to determine a plurality of aspects of said effects emitted from said pest deterring modules, for optimal pest deterring results.

5. The system according to claim 4, wherein said aspects determined and programmed by a user are selected from at least one of the following group: the duration of the effect, the intervals between each effect, the volume of the effect, the extent of movement of a moving part of said system, the sequence of a plurality of said effects, the audio frequency of an audio effect, and the vibration frequency of an effect.

6. The system according to claim 2, wherein said system is modular, allowing detachment and configuration of said components (b), (c), (d), upon said irrigation means (a).

7. The system according to claim 2, wherein said system is water-proof and capable of withstanding outdoor humidity and temperature conditions.

8. The system according to claim 7, wherein said system is able to withstand temperatures within the approximate range of −40 to 60° C.

9. The system according to claim 2, wherein said irrigation means are selected from the group consisting of: dripper irrigation systems and sprinkler systems.

10. The system according to claim 9, wherein said irrigation means are comprised of dripper irrigation systems, and said power generating module is introduced into the dripper tubing during extrusion of said dripper tubing.

11. The system according to claim 2, wherein said power generating module comprises a turbine having a propeller, and a stator comprising metallic coils, and at least one of the following additional components: an axis holder, a magnetic ring associated with said propeller, an electrical connection allowing release of electrical energy from said turbine.

12. The system according to claim 2, wherein said control means comprise a timer for controlling the timing and duration of said emitted pest deterring effects, said timer further capable of providing said system with randomization of the timing of said effects.

13. The system according to claim 2, wherein said control means comprise a central control unit regulating all modules of the system and a plurality of control units, wherein each control unit regulates a single module.

14. The system according to claim 2, wherein said pest deterring module is a sound generating module emitting audio effects, said sound generating module comprised of the following components: a sound memory retained within a memory device, a speaker-driver, a voltage-level handler, and a super-cap/capacitor.

15. The system according to claim 2, wherein said power generating module (b) is adapted to store said electrical power within, and to release said electrical power upon demand.

16. The system according to claim 2, wherein said pest deterring module is a motion generating module, comprised of a base unit having mechanical components, said mechanical components capable of maneuvering at least one moving part.

17. The system according to claim 16, wherein said base unit activates said moving part, utilizing a mechanism selected from: an electromechanical mechanism such as an actuator spring; and a hydro-electrical mechanism such as a fluid entry valve and a fluid exit valve.

18. The system according to claim 2, wherein said pest deterring module is a vibratory generating module, comprised of a vibrating element present within said irrigation means, wherein said vibrating element is manipulated by fluid flow control.

19. The system according to claim 2, wherein the size and shape of said modules of said system allows deployment of said system by unwinding said system from upon a drum.
